(19) United States
(12) Patent Application Publication
(10) Pub. No.: US 2025/0229200 A1
(43) Pub. Date: Jul. 17, 2025

(54) Sulfur Trap with Pressure Relief Safety Device

(71) Applicant: Strom W. Smith, Ocean Springs, MS (US)

(72) Inventor: Strom W. Smith, Ocean Springs, MS (US)

(21) Appl. No.: 19/016,797

(22) Filed: Jan. 10, 2025

Related U.S. Application Data
(60) Provisional application No. 63/620,074, filed on Jan. 11, 2024.

(51) Int. Cl. B01D 19/00

(52) U.S. Cl. CPC B01D 19/0063; B01D 19/0068; B01D 2257/30

(57) ABSTRACT

A sulfur trap provides separation of molten sulfur from a process stream comprising a mixture of sulfur and associated tail-gases. The sulfur trap includes a chamber for receiving the process stream, a float positioned within the chamber and attached to a stopple. The float and stopple allow the float elevation level to control stopple engagement with an orifice in fluid communication with a chamber fluid outlet, specifically to expose the orifice to fluid in the chamber when the float is elevated by molten sulfur and to block the orifice when the float falls with a diminished molten sulfur level. The sulfur trap includes a pressure relief safety device in fluid communication with the fluid outlet and the pressure relief safety device is configured to actuate when pressure within the chamber exceeds a predetermined level. Embodiments of a method of separating liquid sulfur from gases are also provided.

### CROSS-REFERENCE TO RELATED APPLICATIONS

This application claims the benefit of U.S. Provisional Application No. 63/620,074 filed on Jan. 11, 2024, which application is incorporated herein by reference as if reproduced in full below.

### STATEMENT REGARDING FEDERALLY SPONSORED RESEARCH OR DEVELOPMENT

Not Applicable.

### BACKGROUND OF THE INVENTION

Field of the Invention The present invention relates to equipment for separating liquids from associated gases in liquid-gas mixtures. More particularly, the present invention is directed to separation of molten sulfur from process streams having sulfur and gas mixtures, such as oil refineries.

Description of the Related Art Many industrial operations require separation of liquids from associated gases in two-phase mixtures. For example, gaseous compounds containing sulfur, such as hydrogen sulfide, mercaptans, carbonyl sulfide, and carbon disulfide, exist in natural gas. Such gaseous compounds are produced as by-products in petroleum refining operations. Because sulfur has many useful applications and can most easily be transported in molten form, it is often necessary to separate the molten (liquid) sulfur from associated gases.

In industrial applications, gas streams containing sulfur compounds are processed to remove sulfur (primarily in the form of hydrogen sulfide). The gas streams are then further processed to form liquid sulfur in sulfur recovery units. Sulfur recovery units typically include a device (“trap”) to separate molten sulfur from the gas stream.

U.S. Pat. Nos. 5,498,270, 7,112,308, 9,216,372, 9,796,588 and 10,618,809 to the present inventor disclose various sulfur traps that employ a spherical floatation component to aid in preventing tail gases from being discharged with the molten sulfur. These patents are incorporated herein by reference in their entireties. During operation of a sulfur trap, molten sulfur is flowed therefrom via a discharge pipe that comprises an opening within the sulfur trap through which the molten sulfur may enter.

Sulfur separation utilizing a sulfur trap is typically accomplished within an industrial sulfur operations unit. Accordingly, a sulfur trap, as with any other unit component, may experience unintended (“upset”) conditions wherein deviations from standard operating conditions are present. One such upset condition involves higher than desired pressure within the sulfur trap. Such high pressure can result in the breach of the sulfur trap containment properties and potentially cause damage to personnel and/or the environment.

### BRIEF SUMMARY OF THE INVENTION

Embodiments of a sulfur trap of the present invention comprise a pressure relief safety device, such as, but not limited to, a rupture disk (a/k/a pressure safety disk, burst (ing) disk or burst diaphragm) that is fluidly connected to the sulfur trap discharge piping within the sulfur trap. In one aspect, such a configuration provides that if the sulfur trap experiences unintended high internal pressure, then the pressure relief safety device will actuate and internal pressure will be dissipated by flow of liquids and/or gasses via the now increased surface area of disengage pipe openings within the sulfur trap, thereby quickly reducing the pressure.

### BRIEF DESCRIPTION OF THE DRAWINGS

FIG. 1 depicts a partial cross-sectional view of an embodiment of a sulfur trap of the present invention.

FIG. 2 depicts a partial cross-sectional view of another embodiment of a sulfur trap of the present invention.

FIG. 3 depicts a partial cross-sectional view of another embodiment of a sulfur trap of the present invention.

### DETAILED DESCRIPTION OF EXEMPLARY EMBODIMENTS OF THE INVENTION

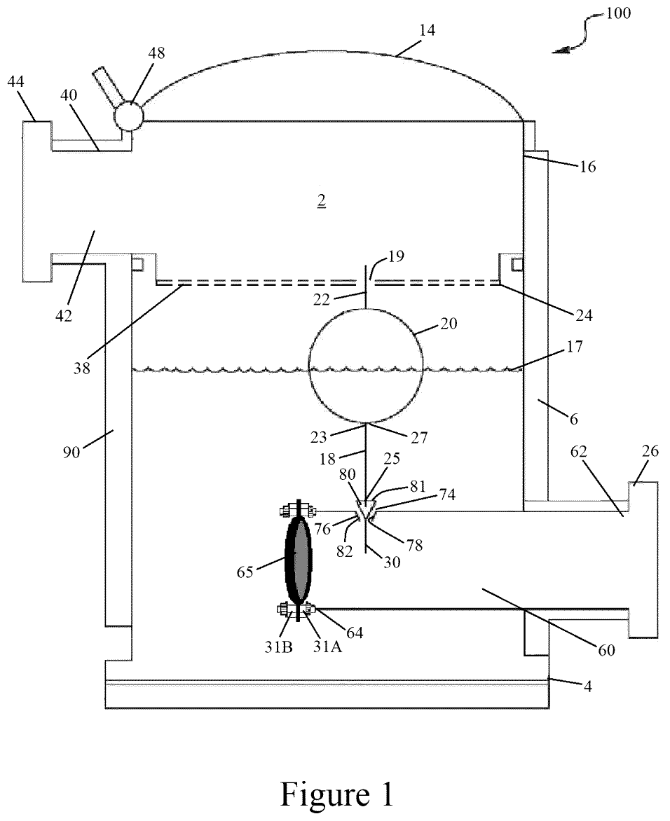

Referring first to FIG. 1, an embodiment of a sulfur trap 100 of the present invention is depicted. In this embodiment, the sulfur trap 100 includes a chamber 2 having a chamber bottom 4 and a vertically oriented, chamber wall 6. In an exemplary embodiment, chamber wall 6 is cylindrical. In one embodiment, a cap 14 seals the upper end 16 of chamber 2. In one embodiment, a cap latch 48 allows for selective opening and closing of cap 14. In one embodiment (not shown), a chamber 2 may be equipped with a vent mechanism, whereby gases may be exuded from a vapor space within the chamber 2, as would be understood by one skilled in the art.

In the embodiment of FIG. 1, a process stream inlet pipe 40 is connected to chamber 2 at inlet opening 42 near upper end 16 of chamber wall 6. Inlet opening 42 is connected to inlet pipe 40 to allow fluid communication from inlet pipe 40 to chamber 2. In one embodiment, inlet pipe 40 is connected to an inlet pipe flange 44. In one aspect, inlet pipe flange 44 is structured for connection to a process stream line (not shown).

In one embodiment, an outlet opening 62 is provided in a lower area 12 of chamber wall 6. In one embodiment, a liquid sulfur outlet pipe 60 extends through outlet opening 62 into chamber 2 in the lower area 12 of chamber wall 6. In one embodiment, outlet pipe 60 has a closed pipe end 64 within chamber 2. In various embodiments, closed pipe end 64 is equipped with a pressure relief safety device 65, as is described in detail below. In one embodiment, a flange 26 is provided on outlet pipe 60 to allow connection of outlet pipe 60 to other discharge piping (not shown).

Still referring to FIG. 1, in one embodiment a sulfur outlet 74 is provided at an upper surface 68 of outlet pipe 60 intermediate closed pipe end 64 and wall 6. In other embodiments (not shown), a sulfur outlet 74 may be provided at a lower surface of outlet pipe 60 intermediate closed pipe end 64 and wall 6. In one embodiment, outlet 74 includes outlet wall 76 fixedly attached or integral to pipe 60. In one embodiment, outlet wall 76 has a stopple-receiving surface 78. In the exemplary embodiment, stopple-receiving surface 78 is beveled, however, the invention is not so limited and other geometries may be employed. In an exemplary embodiment, stopple-receiving surface 78 is beveled at an angle to wall 76 such that an angle of less than 90 degrees is formed in relation to an outer surface 82 of outlet wall 76.

In one embodiment, a float 20 is provided in chamber 2. Float 20 is constructed to be of a density such that float 20 is buoyant in liquid sulfur and further of such density that the weight of float 20 is sufficient to bias a stopple 80 into stopple-receiving surface 78 of outlet 74 when no liquid sulfur or a level of liquid sulfur 17 less than a predetermined quantity is contained within chamber 2. In an exemplary embodiment, float 20 is a hollow metal sphere. Alternative shapes and materials of float 20 may be utilized.

In one embodiment, a first end 23 of float rod 18 is affixed to or integral to lower surface 27 of float 20 and a second end 25 of float rod 18 is affixed to or integral to a top surface 81 of stopple 80. In one aspect, when sufficient liquid is contained within sulfur trap 100, float 20 rises sufficiently for stopple 80 to disengage from stopple-receiving surface 78, thereby allowing liquid to flow through sulfur outlet 74 into outlet pipe 60 and thereby exit sulfur trap 100. Conversely, when insufficient liquid is contained within sulfur trap 100, float 20 descends whereby stopple 80 reengages stopple-receiving surface 78, thereby preventing fluid flow through sulfur outlet 74 such that no fluid flows out of sulfur trap 100 via outlet pipe 60. In one embodiment, a stopple 80 may comprise a positioning rod 30 extending there-beneath. In other embodiments (not shown), alternative mechanisms (e.g., fulcrum and lever) for the displacement of a stopple 80 through vertical movement of a float 20 may be employed, as disclosed in U.S. Pat. Nos. 9,216,372, 9,796,588 and 10,618,809.

In one embodiment, a heat jacket 90 comprising an outer shell encapsulates exterior surfaces of chamber 2. In one aspect, a heat jacket 90 may be heated by introduction thereto of, and flow therefrom of, steam or other heating fluids, as would be understood by one skilled in the art.

In one embodiment, an inner ring 24 is provided on chamber wall 6. Inner ring 24 is provided to support a screen 38. In one embodiment, inner ring 24 and screen 38 are provided below inlet opening 42 and above float 20. In one aspect, screen 38 functions to screen solid-phase materials, including solid-phase sulfur, in the process stream. In one embodiment, an inner ring 24 comprises a guide orifice 19. In one embodiment, a float 20 is equipped with a guide rod 22. In one aspect, horizontal movement of guide rod 22 is restricted by the confines of guide orifice 19, thereby maintaining float 20 in a generally upright orientation.

Still referring to FIG. 1, in one embodiment a pressure relief safety device 65 may be employed to provide pressure relief for the sulfur trap 100. In one embodiment, a relief safety device 65 may comprise a rupture disk that is configured to rupture if the pressure within chamber 2 exceeds a predetermined level. In one embodiment, a rupture disk 65 is sandwiched between two flanges 31A, 31B. In certain embodiments, a rupture disk 65 comprises a membrane comprising one or more layers of material such as, but not limited to, graphite or metal, as would be understood by one skilled in the art. In various embodiments, a rupture disk 65 may comprise one or more metals such as, but not limited to, carbon steel, stainless steel, Hastelloy®, aluminum, nickel, Monel®, Inconel® and/or tantalum. In one embodiment, a “Mono” graphite rupture disk 65 obtained from Zook Enterprises, LLC of Chagrin Fall, OH is utilized, although the invention is not so limited and other graphite rupture disks 65, may be employed. In one embodiment, a graphite rupture disk 65 employed in the present invention may comprise a protective outer coating to prevent corrosion and/or chemical attack by liquid sulfur. In one embodiment, such a protective coating may comprise Teflon® or the like, although the invention is not so limited any useful coating(s) as would be contemplated by one skilled in the art may be employed. In certain embodiments, a rupture disk 65 to be employed may comprise a concave or convex geometry, although the invention is not so limited and a rupture disk 65 comprising a substantially planar geometry may be employed.

In one aspect, a rupture disk 65 may be adapted and configured to actuate (burst) at any useful pressure. In one embodiment, a burst pressure of about 20 PSIG to about 25 PSIG may be employed. In one aspect, a rupture disk 65 may be adapted and configured to be employed an elevated operating temperatures. In one embodiment, a rupture disk 65 may be employed at 400° F. or a higher temperature. In one embodiment (not shown), a sulfur trap 100 may be equipped with one or more cutting components disposed proximate outlet pipe 60 closed pipe end 64. In one aspect such cutting components (e.g., knife-like blades) may serve to at least partially shred a rupture disk 65 that has burst in order to further enlarge the opening to outlet pipe 60 created by the bursting of rupture disk 65, as would be understood by one skilled in the art.

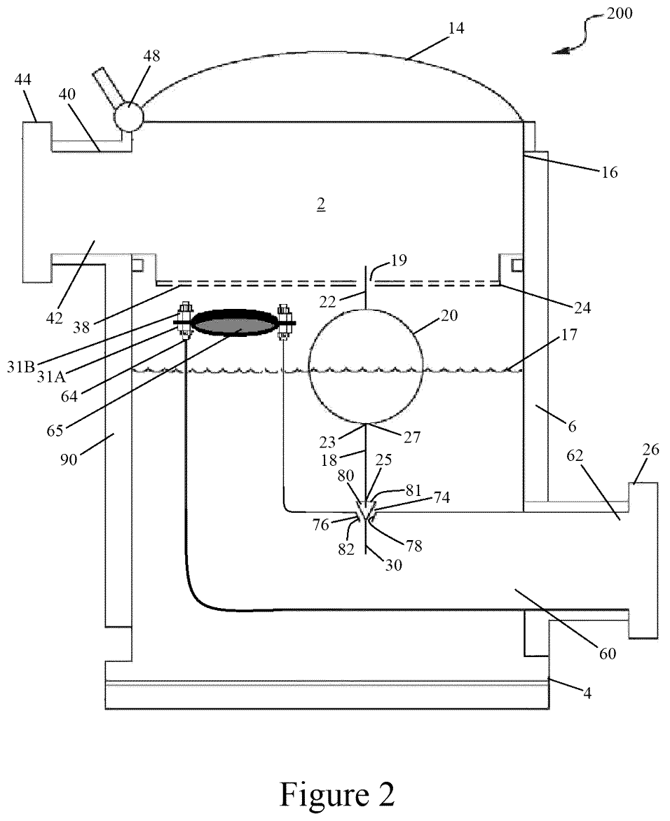

Referring now to FIG. 2, an embodiment of a sulfur trap 200 of the present invention is depicted. In this embodiment, outlet pipe 60 comprises an elbow (not separately labeled) and is extended such that closed pipe end 64 thereof is positioned above the sulfur level 17. In one aspect, this mitigates potential damage to rupture disk 65 due to degradation by liquid sulfur or otherwise. While in the embodiment depicted in FIG. 2 the rupture disk 65 is disposed beneath the screen 38, the invention is not so limited and in other embodiments (not shown) the outlet pipe 60 may extend through the screen 38 such that the rupture disk 65 is disposed there-above.

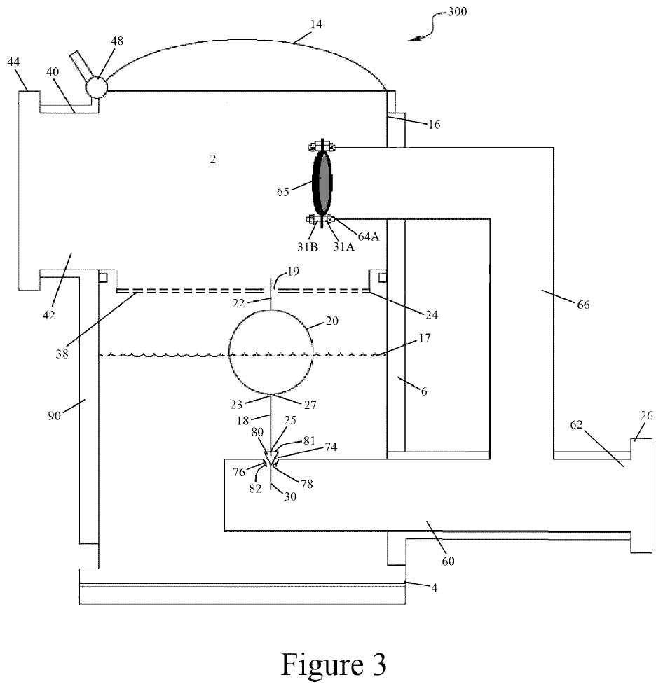

In other embodiments, a pressure relief safety device may be employed within a sulfur trap of the present invention wherein the rupture disk 65 is not in direct fluid communication with the outlet pipe 60, but rather in direct fluid communication with an “emergency” piping member that provides for fluid flow out of the chamber 2 that is only subjected to fluid flow when the rupture disk 65 is actuated. One such embodiment is depicted in FIG. 3 as sulfur trap 300.

Referring now to FIG. 3, an embodiment of a sulfur trap 300 of the present invention is depicted. In this embodiment, an (emergency) piping member 66 is provided in fluid communication with outlet pipe 60. In the embodiment of FIG. 3, the rupture disk 65 is positioned above screen 38, although the invention is not so limited and other positioning may be employed. In one embodiment (not shown), at the junction of piping member 66 and outlet pipe 60 a check valve may be provided to allow for fluid flow from piping member 66 into outlet pipe 60 and prevent fluid flow from outlet pipe 60 into piping member 66, as would be understood by one skilled in the art.

In other embodiments (not shown), two or more pressure relief safety devices may be employed within a sulfur trap 100, 200 or 300 wherein at least one rupture disk is in direct fluid communication with the outlet pipe 60 and at least one rupture disk 65 is not in direct fluid communication with the outlet pipe 60, but rather in direct fluid communication with an “emergency” piping member that provides for fluid flow out of the chamber 2 that is only subjected to fluid flow when that rupture disk 65 is actuated.

### Operation

In operation, a process stream (not shown) comprising a liquid-gas mixture process stream, and from time-to-time including solid-phase precipitate, is transmitted to chamber 2 through inlet pipe 40. As flow through inlet pipe 40 contains a gas phase of the process stream, gas components are naturally circulated into and out of chamber 2 through pipe 40. Liquid-phase process stream components, generally sulfur (not shown) falls through screen 38 downward in chamber 2. Particulate matter exceeding opening sizes of screen 38 are retained on screen 38.

As liquid accumulates in chamber 2, chamber 2 partially fills and from time to time reaches a level to cause float 20 to float in the liquid sulfur. As the liquid level 17 increases float 20 will float upward and thus pull stopple 80 upward, thereby allowing liquid to drain from chamber 2 into outlet pipe 60 via outlet 74, and then flow out of sulfur trap 100 through outlet pipe 60. As liquid is discharged from chamber 2 through outlet pipe 60, float 20 lowers, thereby causing stopple 80 to move downward until stopple 80 sealingly engages stopple-receiving surface 78, thereby preventing liquid from flowing into outlet pipe 60 via outlet 74.

If the pressure within a sulfur trap 100 or 200 chamber 2 becomes elevated above a predetermined set point, whether due to operational fluctuations or external forces, the pressure within chamber 2 bursts the rupture disk 65. In one aspect, this could occur whether or not liquid is flowing into outlet pipe 60 via outlet 74. When the rupture disk 65 bursts, pressurized fluid within chamber 2 can flow into outlet pipe 60 through now-open end 64 thereof. In one aspect, this reduces the pressure within chamber 2 and reduces the chance of rupture or explosion, as would be understood by one skilled in the art.

If the pressure within a sulfur trap 300 chamber 2 becomes elevated above a predetermined set point, whether due to operational fluctuations or external forces, the pressure within chamber 2 bursts the rupture disk 65. In one aspect, this could occur whether or not liquid is flowing into outlet pipe 60 via outlet 74. When the rupture disk 65 bursts, pressurized fluid within chamber 2 can flow through piping member 66 into outlet pipe 60 through now-open end 64A thereof. In one aspect, this reduces the pressure within chamber 2 and reduces the chance of rupture or explosion, as would be understood by one skilled in the art.

### Method

In one embodiment, a method of separating liquid sulfur from a process stream containing a mixture of liquid sulfur and gas-phase components utilizing a sulfur trap comprising a pressure relief safety device includes:

A Sulfur Trap Provision Step, comprising providing a sulfur trap, such as sulfur trap 100, 200 or 300, comprising a pressure relief safety device, such as rupture disk 65;

A Sulfur Transmission Step, comprising transmitting a process stream comprising liquid sulfur into a chamber, such as chamber 2;

A Screening Step, comprising screening particulate matter from the process stream by means of screen, such as screen 38;

A Liquid Collection Step, comprising collecting liquid sulfur in the chamber;

A Stopple Release Step, comprising allowing a float, such as float 20, to be biased upward by a rise in the level of liquid sulfur within the chamber, whereby a stopple, such as stopple 80, is disengaged from a stopple-receiving surface, such as stopple-receiving surface 78 of an outlet, such as outlet 74, that is in fluid communication with an outlet pipe, such as outlet pipe 60;

A Liquid Discharge Step, comprising discharging liquid sulfur from the chamber through the outlet and the outlet pipe, such step continuing until sufficient liquid sulfur is discharged such that the amount of liquid sulfur contained in the chamber is sufficiently reduced such that the float is sufficiently lowered such that the stopple reengages with the stopple-receiving surface, again sealingly engaging the outlet; and

A Pressure Relief Step, comprising the occurrence of an elevated pressure situation within the chamber, wherein the pressure causes the rupture disk to actuate, whereby at least a portion of the fluid within the chamber flows through the outlet pipe via the opening formed by actuation of the rupture disk.

The foregoing method is merely exemplary, and additional embodiments of the present invention utilizing a sulfur trap comprising a pressure relief safety device consistent with the teachings herein may be employed. In addition, in other embodiments, one or more of these steps may be performed concurrently, combined, repeated, re-ordered, or deleted, and/or additional steps may be added.

While the embodiments of the apparatus, operation and method of utilizing the present invention are directed to the sulfur traps 100, 200 and 300 depicted in FIGS. 1, 2 and 3, respectively, the invention is not so limited and the teachings herein may be employed with other sulfur trap designs, such as, but not limited to, those disclosed in U.S. Pat. Nos. 5,498,270, 7,112,308, 9,216,372, 9,796,588 and 10,618,809.

While the embodiments of the apparatus, operation and method of utilizing the present invention are directed to the sulfur traps, the invention is not so limited and the teachings herein may be employed with other liquid separation apparatuses, as would be understood by one skilled in the art.

The foregoing description of the invention illustrates exemplary embodiments thereof. Various changes may be made in the details of the illustrated construction and process within the scope of the appended claims without departing from the teachings of the invention. The present invention should only be limited by the claims and their equivalents.

I claim:

1. A separation apparatus for separation of a liquid from a liquid-gas process stream comprising:
a chamber;
a chamber fluid inlet;
a chamber liquid outlet;
a chamber liquid level control system; and
one or more pressure relief safety devices;
wherein:
said chamber liquid outlet is disposed below said chamber fluid inlet;
said chamber liquid level control system comprises a float;
said float is attached to a stopple;
at least one said pressure relief safety device is in fluid communication with said chamber liquid outlet;
rise of said float raises said stopple from a position of engagement with a stopple-receiving surface of an orifice that is in fluid communication with said chamber liquid outlet, thereby allowing liquid within said chamber to flow through said orifice and said chamber liquid outlet;
fall of said float lowers said stopple back into a position of engagement with said stopple-receiving surface, thereby preventing said liquid from flowing from said chamber through said orifice into fluid communication with said chamber liquid outlet; and
elevation of pressure within said chamber in excess of a predetermined level results in actuation of at least one said pressure relief safety device, thereby allowing fluid within said chamber to flow through said chamber liquid outlet.

2. The separation apparatus of claim 1 wherein at least one said pressure relief safety device comprises a rupture disk.

3. The separation apparatus of claim 2 wherein at least one said rupture disk comprises at least one metal selected from the group consisting of:
carbon steel;
stainless steel;
Hastelloy®
aluminum;
nickel;
Monel®;
Inconel®; and
tantalum.

4. The separation apparatus of claim 2 wherein at least one said rupture disk comprises graphite.

5. The separation apparatus of claim 4 wherein at least one said graphite rupture disk is at least partially externally coated with a substance or substances to prevent corrosion and/or chemical attack by liquid sulfur.

6. The separation apparatus of claim 1 wherein at least one said pressure relief safety device is disposed beneath a desired operational liquid level within said chamber.

7. The separation apparatus of claim 1 wherein at least one said pressure relief safety device is disposed above a desired operational liquid level within said chamber.

8. A separation apparatus for separation of a liquid from a liquid-gas process stream comprising:
a chamber;
a chamber fluid inlet;
a chamber liquid outlet;
a chamber liquid level control system;
a screen; and
one or more pressure relief safety devices;
wherein:
said chamber liquid outlet is disposed below said chamber fluid inlet;
said chamber liquid level control system comprises a float;
said float is attached to a stopple;
at least one said pressure relief safety device is in direct fluid communication with a piping member that is in fluid communication with said chamber liquid outlet;
said screen functions to screen solid-phase materials, including solid-phase sulfur, in the process stream;
at least one said pressure relief safety device is disposed above said screen;
rise of said float raises said stopple from a position of engagement with a stopple-receiving surface of an orifice that is in fluid communication with said chamber liquid outlet, thereby allowing liquid within said chamber to flow through said orifice and said chamber liquid outlet;
fall of said float lowers said stopple back into a position of engagement with said stopple-receiving surface, thereby preventing said liquid from flowing from said chamber through said orifice into fluid communication with said chamber liquid outlet; and
elevation of pressure within said chamber in excess of a predetermined level results in actuation of at least one said pressure relief safety device disposed above said screen, thereby allowing fluid within said chamber to flow through said chamber liquid outlet via said piping member.

9. The separation apparatus of claim 8 wherein at least one said pressure relief safety device comprises a rupture disk.

10. The separation apparatus of claim 9 wherein at least one said rupture disk comprises at least one metal selected from the group consisting of:
carbon steel;
stainless steel;
Hastelloy®;
aluminum;
nickel;
Monel®;
Inconel®; and
tantalum.

11. The separation apparatus of claim 9 wherein at least one said rupture disk comprises graphite.

12. The separation apparatus of claim 11 wherein at least one said graphite rupture disk is at least partially externally coated with a substance or substances to prevent corrosion and/or chemical attack by liquid sulfur.

13. A method of separating liquid from a liquid-gas process stream, comprising:
providing the apparatus of claim 1;
introducing a fluid flow of said process stream into said apparatus via said chamber fluid inlet; and
alleviating an over-pressure of said chamber via actuation of at least one said pressure relief safety device.

14. The method of separating liquid from a liquid-gas process stream of claim 13 wherein at least one said pressure relief safety device comprises a rupture disk.

15. The method of separating liquid from a liquid-gas process stream of claim 14 wherein at least one said rupture disk comprises at least one metal selected from the group consisting of:
carbon steel;
stainless steel;
Hastelloy®;
aluminum;
nickel;
Monel®;
Inconel®; and
tantalum.

16. The method of separating liquid from a liquid-gas process stream of claim 14 wherein at least one said rupture disk comprises graphite.

17. The method of separating liquid from a liquid-gas process stream of claim 16 wherein at least one said graphite rupture disk is at least partially externally coated with a substance or substances to prevent corrosion and/or chemical attack by liquid sulfur.

18. The method of separating liquid from a liquid-gas process stream of claim 13 wherein at least one said pressure relief safety device is disposed beneath a desired operational liquid level within said chamber.

19. The method of separating liquid from a liquid-gas process stream of claim 13 wherein at least one said pressure relief safety device is disposed above a desired operational liquid level within said chamber.

20. The method of separating liquid from a liquid-gas process stream of claim 13 wherein:
said separation apparatus comprises a screen that functions to screen solid-phase materials, including solid-phase sulfur, in the process stream;
at least one said pressure relief safety device is disposed above said screen;
at least one said pressure relief safety device disposed above said screen is in direct fluid communication with a piping member that is in fluid communication with said chamber liquid outlet; and
elevation of pressure within said chamber in excess of a predetermined level results in actuation of at least one said pressure relief safety device disposed above said screen, thereby allowing fluid within said chamber to flow through said chamber liquid outlet via said piping member.
